(19) United States
(12) Patent Application Publication
(10) Pub. No.: US 2013/0006733 A1
(43) Pub. Date: Jan. 3, 2013

(54) SOCIAL NETWORKING RELATIONAL REWARD SYSTEM

(76) Inventor: Robert Fisher, Atlanta, GA (US)

(21) Appl. No.: 13/172,827

(22) Filed: Jun. 30, 2011

(51) Int. Cl. G06Q 30/00

(52) U.S. Cl. 705/14.12; 705/14.16

(57) ABSTRACT

Methods for operating a reward program are provided. The method allows rewarding members of social media sites based on their online or offline activities, based on such activities of members connected to them. The disclosed method encourages Internet users to spread commerce-related content via social media sites to connected members for a reward. The method may comprise receiving a log file of a user activity at a reward program site, the user being a member of one or more social media sites, ascertaining one or more connected members who are connected to the user within the one or more social media sites, determining whether the one or more connected members triggered the user activity, and providing a reward to the one or more connected members who triggered the user activity and/or to the user based on predetermined criteria.

### TECHNICAL FIELD

This disclosure relates generally to incentive rewarding and, more specifically, to incentive programs to reward members of social networks responsive to their activity on the Internet.

### BACKGROUND

The approaches described in this section could be pursued but are not necessarily approaches that have been previously conceived or pursued. Therefore, unless otherwise indicated, it should not be assumed that any of the approaches described in this section qualify as prior art merely by virtue of their inclusion in this section.

Social networking sites, blogs, micro-blogs, news feeds, e-mail subscriptions, and other social media utilities are widely used by companies and individuals to distribute commercial information to encourage Internet users to make purchase decisions related to their products or services. Companies wish to motivate users to distribute marketing content to their social network contacts. Commercial sites may comprise links to social networking sites or blogs so that users may easily share their experiences related to a service or a product by clicking these links. The content is then shared with the members of an appropriate social networking site. For example, a user may buy a new product at a vendor site, and then select the “Share” button related to the purchase. As a result, a message may be posted on the social networking site so that the contacts of the posting member can view the message in the news feed or by navigating to the member profile.

The sharing feature provided by different social media sites is helpful to spread commercial information, drive traffic to the affiliated sites, and increase the number of product and service purchased. However, it is difficult to track user activities in sharing promotional information within social media. In addition, without an incentive users can be unwilling to share commercial information.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In accordance with various embodiments and the corresponding disclosure thereof, a new incentive reward program is provided. The program allows rewarding members of social media sites based on their activity on the Internet or in real vendor stores or service providers, or based on such activity of members connected to them within social media. The disclosed program may encourage Internet users to spread commercial content via social networks to their contacts for a reward.

In one embodiment, a computer-implemented method for operating a reward program is provided. The method may comprise receiving a log file related to user activity at a reward program site, the user being a member of one or more social media sites, ascertaining one or more connected members who are connected to the user within the one or more social media sites, determining whether the one or more connected members triggered the user activity, and providing a reward to the one or more connected members who triggered the user activity and/or to the user based on predetermined criteria.

The user activity may comprise one or more of the following events: a purchase, a click, a site visit, playing a game, registering, answering a trivia question, signing up for a service or a product, wining a contest, taking a survey, a mobile check in, taking a picture and scanning a code, RSVP to an event, writing a review, and posting a comment.

According to various embodiments, the method may further comprise receiving user credentials, with the user credentials being used for accessing one or more social media sites or the reward program site.

In one example, the determining of one or more connected members includes determining of 1st, 2nd, and 3rd degree of connection relationship between the user and connected members. The 1st degree designates two or more members that are directly connected within one or more social media sites, the 2nd degree designates two or more members that are connected to each other via a common member, and the 3rd degree designates two or more members that are connected to each other via two intermediate members, who are in turn directly connected to each other, and separately connected to the mentioned two or more members.

Providing a reward to the user and/or connected member may be based on the degree of connection relationship. The reward for a member of 1st, 2nd, or 3rd degree can be a certain percentage of the reward assigned to the user or another member. The amount of the reward provided to the connected members may depend on the number of activities performed within a predetermined time period. The user activity may be performed at the reward program site, on an affiliated site, a vendor store, or a service provider.

According to various embodiments, the method may further comprise determining the relationships among connected members in different two or more social media sites. The method may further comprise determining the 1st, 2nd, and 3rd degree of connection relationship among connected members in different two or more social media sites, and determining overlapping relationships between connected members. The method may further comprise determining the user activity within a set or variable periods of time, wherein the user activity is measured in activity points. The method may further comprise assigning a rank to the user or connected members depending on their activity points. The providing a reward to the one or more connected members or the user may be based on the assigned rank.

The method may further comprise navigating the user to the reward program site to incorporate the user's person-to-person connections in one or more social networks. The method may further comprise generating a log file of the user activity at the reward program site or affiliated sites, and tracking the user activity by processing the log file. The method may further comprise storing log files in a member database, and storing a reward amount in a reward database.

According to various embodiments, the reward may comprise one or more of monetary incentive, non-monetary incentive, virtual money, reward points, bonus points, a financial discount percentage, a rebate amount, a free service, and a free product. The one or more social media may comprise a social networking site, a blog, a micro-blog, software, a computer game, and a mobile application.

According to various embodiments, the predetermined criteria may comprise one or more of demographic data, age, gender, occupation, geographical location of the user or one or more connected members, a purchase amount, amount spent, and a number of connected members. The reward can be provided to those connected members and/or the user who has profile data within the one or more social media sites satisfying the predetermined criteria. The amount of reward can be calculated based on the predetermined criteria.

In yet another embodiment, an apparatus for operating a reward program is provided. The apparatus may comprise at least one processor configured to: receive a log file of user activity at a reward program site, with the user being a member of one or more social media sites, ascertain one or more connected members who are connected to the user in the one or more social media sites, determine whether the one or more connected members triggered the user activity, and provide a reward to the one or more connected members who triggered the user activity and/or to the user based on predetermined criteria. The apparatus may further comprise a memory coupled to the at least one processor, the memory comprising codes for the at least one processor.

In yet another embodiment, a computer-readable medium is provided. The computer-readable medium may have instructions stored thereon, which when executed by one or more computers, cause the one or more computers to receive a log file of user activity at a reward program site, with the user being a member of one or more social media sites, ascertain one or more connected members who are connected to the user within the one or more social media sites, determine whether the one or more connected members triggered the user activity, and provide a reward to the one or more connected members triggered the user activity and/or to the user based on predetermined criteria.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Embodiments are illustrated by way of example and not limitation in the figures of the accompanying drawings, in which like references indicate similar elements and in which:

FIG. 1 is a block diagram illustrating a system environment suitable for operating a reward program according to an example embodiment.

FIG. 2 is a diagram of the reward system according to an example embodiment.

FIG. 3 illustrates a method for operating a reward program according to an example embodiment.

FIG. 4 illustrates a method for operating a reward program according to another example embodiment.

FIG. 5 illustrates a method for determining members of the 1st, 2nd, 3rd degree of connection relationship according to example embodiment.

FIG. 6 is a diagrammatic representation of an example machine in the form of a computer system within which a set of instructions, for the machine to perform any one or more of the methodologies discussed herein, is executed.

### DETAILED DESCRIPTION

The following detailed description includes references to the accompanying drawings, which form a part of the detailed description. The drawings show illustrations in accordance with example embodiments. These example embodiments, which are also referred to herein as “examples” are described in enough detail to enable those skilled in the art to practice the present subject matter. The embodiments can be combined, other embodiments can be utilized, or structural, logical and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or”, such that “A or B” includes “A but not B”, “B but not A”, and “A and B”, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The embodiments described herein can be implemented by various means, depending upon the application. For example, embodiments can be implemented in hardware, firmware, software, or a combination thereof. For a hardware implementation, embodiments can be implemented with processors, controllers, micro-controllers, microprocessors, electronic devices, other electronic units designed to perform the functions described herein, or a combination thereof. Memory can be implemented within a processor or external to the processor. As used herein, the term “memory” refers to any type of long term, short term, volatile, nonvolatile, or other storage device and is not to be limited to any particular type of memory or number of memories, or type of media upon which memory is stored. For a firmware and/or software implementation, embodiments can be implemented with modules such as procedures, functions, and so on, that perform the functions described herein. Any machine readable medium tangibly embodying instructions can be used in implementing the embodiments described herein.

The embodiments disclosed herein relate to rewarding Internet users responsive to their online or offline activity, and responsive to triggered activity of a connected member of a social media site.

The term “social media site” is used herein to refer to various online and software tools that enable people to communicate via a network such as the Internet and share information and resources. Social media can include text, audio, video, images, podcasts, and other multimedia communications. Typical social media tools are social networking systems (sites), blogs, micro-blogs, podcasts, chats, web feeds (or news feeds, RSS feeds), content sharing tools, and so forth.

Implementations of social media sites may vary. For example, implementation of a social networking site or a blogging site may provide mechanisms for members to communicate with each other, form connections with each other, store information, and share information of interest, among other things. Members may join social networking systems and then add connections to a number of other members to whom they desire to be connected. Traditionally, such connected members are known as “friends”. Social networking sites and blogging sites maintain member profiles for each member. Any action that a particular member takes with respect to another member or any other action on any objects maintained on the social networking and blogging sites may be logged in association with the member's profile. The logged actions may then be tracked by members or non-members by reviewing the member's profile. The logged actions may include, for example, adding new content (a post, a blog entry, a comment, a message, etc.), adding a connection to another member, sending/reading messages, and so forth. Any action taken by members may be recorded in a log file or the alike. The log files can be stored in a database and accessed in case of a necessity.

As used herein, “social media” may also refer to software allowing people to play games among other things. The software can be embedded within a client device, e.g. it can be implemented as a mobile application or the like.

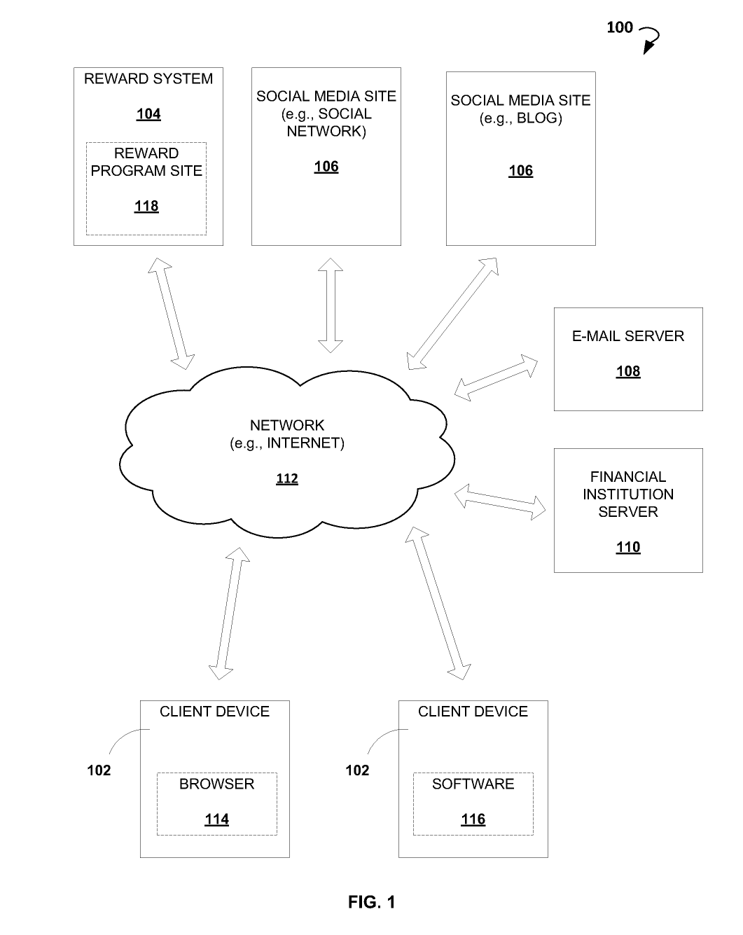

Referring now to the drawings, FIG. 1 shows a block diagram illustrating a system environment 100 suitable for operating a reward program according to an example embodiment. The system environment 100 comprises one or more client devices 102, a reward system 104, one or more social media sites 106, one or more e-mail servers 108, one or more financial institution server 110, and a network 112. The network 112 may couple the aforementioned modules.

The implementation described below may include a client-server environment. The Internet is one example of a client-server environment. However, any other appropriate type of client-server environment, such as an intranet, a wireless network, a telephone network, peer-to-peer network, and the like may be also used.

As used herein, the term “client device” refers to a computer, a laptop, a tablet computer, a portable computing device, a personal digital assistant (PDA), a handheld cellular phone, a mobile phone, a smart phone, a cordless telephone, a handheld device having wireless connection capability, or any other electronic device with the ability to receive and transmit data via a cord or cordless network (e.g. with the ability to browse the Internet).

In some embodiments, the client devices 102 may comprise a browser 114 providing the ability to browse and interact with sites on the Internet. In some other embodiments, the client devices 102 may comprise software 116 to communicate with the reward system 104. In one example, the software 116 is a mobile application embedded in the client device 102. In yet another example, the software 116 is a game application embedded within the client device 102.

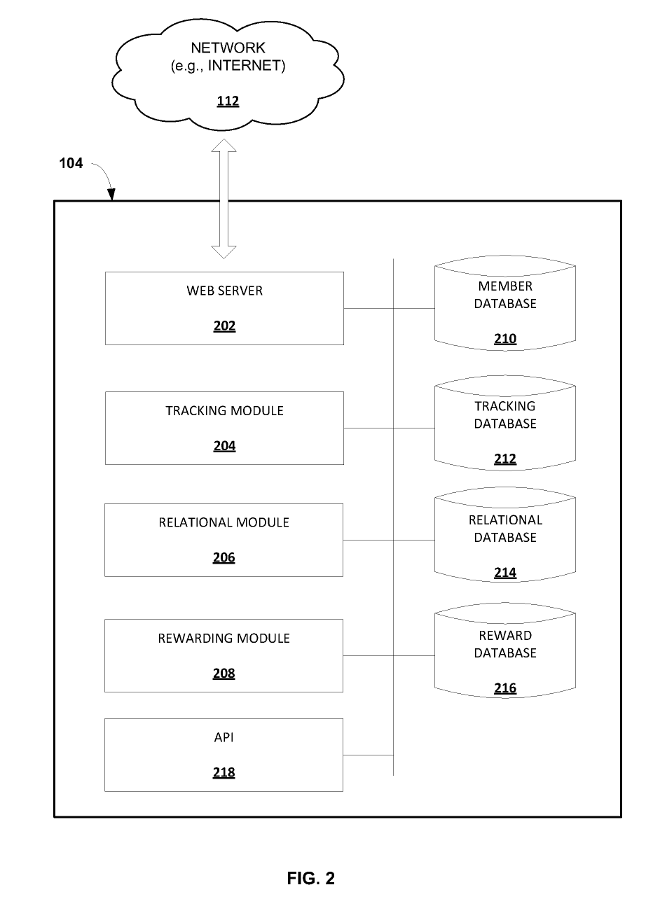

The reward system 104 may be configured to operate a reward program according to various embodiments disclosed herein. The reward system 104 may also host a reward program site 118 for users to participate in a reward program according to various embodiments. The reward system 104 can be implemented as a server having multiple modules and databases. The reward system 104 is described in more detail below with reference to FIG. 2.

The social media site 106 may include a social networking site (e.g. Facebook®, LinkedIn®, etc.), a blogging site (e.g. Blogger®, WordPress®, etc.), a micro-blogging site (e.g. Twitter®), a podcasting site, a web feed server (an RSS server), a forum site, an information aggregator site, a social bookmarking site, a media platform, a game platform, a content sharing platform, and so forth. According to various embodiments, the client devices 102 may interact with the social media sites 106 by communicating transmissions via the network 112.

The e-mail server 108 may transfer e-mail messages from one computer to another computer, using client-server application architecture. The e-mail server 108 may be used by one client device 102 to send a message to another client device 102, or may be used by the reward system 104 to send messages to the client devices 102.

The financial institution server 110 may include a banking server, a clearing server, a credit/debit/prepaid card server, a virtual account server, an on-line banking server, and so forth. In this disclosure, the term “financial institution” means any organization in the business of transacting money and providing financial services. Financial institutions, such as commercial banks, provide services related to establishing bank accounts, cash withdrawals and deposits, issuing credit cards, debit cards, and so forth. The financial institution server 110 may be associated with user payment cards (such as credit, debit or prepaid cards), and it can be used to make payments by cardholders and/or receive payments from any organizations or individuals.

FIG. 2 is a diagram of the reward system 104 according to an example embodiment. In this embodiment, the reward system 104 may include a web server 202, a tracking module 204, a relational module 206, a rewarding module 208, a member database 210, a tracking database 212, a relational database 214, a reward database 216, and an Application Programming Interface (API) 218. In other embodiments, the reward system 104 may include additional, fewer, or different modules for various applications.

The web server 202 may connect the reward system 104 to one or more client devices 102, one or more social media sites 106, the e-mail server 108, one or more financial institutions 110 via the network 112. The connection and data transfer may be provided via an API interface. For example, the reward system 104 may access the social media site 106 using its API (e.g., Facebook Connect®). In some example embodiments, the one or more social media sites 106 may utilize Near Field Communication (NFC) technology for simplified transactions, data exchange, and connections with a touch. The NFC may allow sharing, pairing, and transactions between client devices.

The web server 202 can be implemented as hardware having software installed thereon that implements the steps necessary to operate reward program according to various embodiments disclosed herein. The web server 202 may also host the reward program site 118 directed to manage user participation in the reward program, create and manage member profiles, track their activity or activity of other members, manage rewarding functionality (such as redeeming earned reward points), access one or more databases 210-216, provide information related to membership in social media sites, information related to connected members, and so forth.

The reward program site 118 may also be used by users to review commercial information (such as coupons), make purchases, playing games, registering, answering trivia, signing up for a service or a product, participating in a contest, taking a survey, taking a picture and scanning a code, RSVP to an event, writing a review, posting a comment, and so forth.

According to various embodiments, the user may first register with the reward program site 118 and create a member profile. If this is the case, the membership details are stored in the member database 210. The membership profile stored in the member database 210 may store user information, such as a name, a nickname, user credentials, a representative picture/photo, address, phone number, fax number, e-mail address, snail mail address, age, gender, occupation, financial institution account details, or other form of contact and personal information. The member profile may also comprise user credentials related to one or more social media sites, which also have a profile of this user. The user may also manage his or her profile in the member database 210. In addition, the reward program site 118 may manually or automatically access one or more social media sites using user credentials to retrieve contact information of the user, details of connected members, to post message sharing information, and the like. The reward program site 118 may also enable communications with other members and sharing information including resources. According to another embodiment, the reward program site 118 may allow members to share information via one or more social media sites 106 with connected members.

Pursuant to the example embodiment, the tracking module 204 may track user activity on the Internet or offline activity (e.g. track purchases made in vendor or service provider stores). In one example, users registered with one or more social media site 106 (the user may also optionally be registered with the reward program site 118), can make a reward program related action and, in response, the tracking module 204 can generate a log file. The reward program related action or “user activity” action may relate to one or more of the following: a purchase (via online or offline store), a click, a site visit, playing a game, registering, answering a trivia question, signing up for a service or a product, wining a contest, taking a survey, mobile check in, taking a picture and scanning a code, sharing information, RSVP to an event, writing a review, posting a comment, and so forth. The log files generated by the reward system 104 is then stored in the tracking database 212 in correspondence with the member profile.

The tracking module 204 may track activities of members connected to the user via one or more social networks (i.e. the tracking module 204 tracks activities of user “friends”). In one example, the user may share with connected members commercial information (e.g. coupons and promotional offers), and if such one or more connected members review this information and make a purchase, the activity is stored in the tracking database 212 in one or more log files in association with the user and such connected member who made the purchase. Further, if the connected members share commercial information with their connected members (i.e. the information is delivered to “friends of friends”), and if these connected members of connected members make a reward program related action, then the activity can also be stored in the tracking database 212 in association with the user, the connected members who shared the content to the member who made the purchase, and the member who made the purchase.

Each activity action can be assigned with activity points. Amount of activity points may vary depending on the action and a number of actions. In addition, tracking of user activity can be performed within certain time limits or variable time limits. The activity points can be calculated by the end of predetermined time period, for example, by the end of each month. Moreover, members of social media sites 106 or the reward program site 118 or any affiliated sites may be provided with a rank depending on their activities (number of actions). The activity points and ranks can be stored in the tracking database 212 in association with a corresponding member profile stored in the member database 210.

User activities and activities of connected members can also be tracked depending on demographic, geographic or other factors. For example, activity actions can be tracked for only those users and connected members that are located within a certain geographical region, or relate to a certain age group. In other words, filters can be used to track and separate user activity on the Internet.

Generally, demographics data comprises one or more of an age, a gender, an occupation, a geographical location of the user or one or more connected members, a purchase amount, spent amount, a number of connected members.

In general, the tracking module 204 may be configured to receive log files (or any other transmissions), from the reward program site 118 or social media sites 106 or any affiliated sites, defining a particular activity of the user or connected members, and store/retrieve such log files in/from the tracking database 212. The tracking module 204 may be further configured to assign activity points and ranks relative to activity of the user or connected members.

The relational module 206 may be configured to determine connected members of one or more social media sites 106 relative to each user registered in the member database 210. The relational module 206 may also determine which members of one or more social media sites 106 are connected. In other words, the relational module 206 may be configured to determine 1^{st}, 2^{nd}, and 3^{rd} degree of connection relationship between connected members. In terms of this document, the 1^{st} degree relates to two or more members that are directly connected to each other (i.e. “friends”) within the reward program site 118 or the social media site 106. The 2^{nd} degree relates to two or more members that are connected to each other via a common connected member (in other words, “friends of friends”). The 3^{rd} degree relates to two or more members that are connected to each other via two intermediate connected members that are in turn directly connected to each other, and separately and independently to mentioned two or more members. In other words, 3^{rd} degree relates to friends of friends of the user.

The relational module 206 may be configured to determine connected members of one or more social media sites 106 automatically or manually. For example, when the user makes a reward program related action, it may be ascertained what connected members does the user have in one or more social media sites 106 or the reward program site 118. Alternatively, when the user is registered at the reward program site 118 he or she may be asked to allow accessing their accounts at the one or more social media sites 106 to retrieve information related to their connected members (i.e. friends).

The relational module 206 may be further configured to determine whether there are any overlapping connections. For example, one user may have same contact members in two or more different social media sites 106. If this is the case, similar connected members are merged or combined together and considered a single connected member.

All determined relational contacts may be stored in the relational database 214 in association with the member profile stored in the member database 210.

The rewarding module 208, in general, may be configured to determine which members are to be provided with a reward, calculate the reward amount, and provide the reward to one or more users registered with the reward program site 118.

More specifically, when a predetermined activity is performed by the user, it may be determined whether there are any connected members of the user that triggered such activity. First, the log may be analyzed to ascertain who invited the user to perform the activity. If there is no such member then a reward (activity points) is assigned to this user only. If there is a connected member who invited the user to make a reward program related action, then a reward may be provided to both the user and the connected member or to the user only. Furthermore, if there are at least two connected members (2nd degree) the reward may go to all connected members and the user, to one connected member and the user, or to the user only. Finally, if there are at least three connected members (3^{nd} degree) the reward may go to all connected members and the user, to only one, two or three of the connected members, or to the user only. Relational connections can be retrieved by the rewarding module 208 from the relational database 214.

In other words, the reward program can be operated as follows. A first member of the reward program site 118 may send an invitation to make a purchase (as an example) of a specific product to its connected members of the social media site 106. If any of these connected members (i.e. the second member) make a purchase following the invitation, reward points can be provided to the first member and the second member. Furthermore, the second member may also share or re-send the invitation of the first member to the connected members of the second member (“friends of friends” or the third member). In this case, if any one of the third members makes a purchase following this invitation, the reward can be provided to the first, second, and third members. This technique may further be extended to “friends of friends of friends” connection, and may be implemented differently. In other examples, members may also share digital content, links, and so forth.

According to various embodiments disclosed herein, a reward refers to any monetary and non-monetary incentives, and includes one or more of the following: money, virtual money, reward points, a financial discount percentage, a rebate amount, a free service, a free product, cash back rebate, and so forth.

The amount of reward may depend on one or more of the following: the degree of connection relationship (1^{st}, 2^{nd}, 3^{rd} degree), a type of activity, the price of the made purchase, a number of connected members, a number of purchases associated with the shared content, a rank of the members, a number of activity points, and so forth.

The reward can be calculated based on predetermined criteria set by the user, a merchant, a promotional program officer, and so forth. The predetermined criteria may comprise one or more of demographic data, an age, a gender, an occupation, a geographical location of the user or one or more connected members, a purchase amount, spent amount, and a number of connected members. The reward can be provided to those connected members and/or the user who has profile data within the one or more social media sites 106 satisfying the predetermined criteria.

The rewarding module 208 may be configured to calculate a reward based on a corresponding rewarding method and provide a reward to the user and one or more connected members via one or more of the following destinations. If the reward is monetary, the rewarding module 208 may request one or more financial institution servers 110 (e.g. PayPal®) to credit corresponding accounts of the members with the amount stipulated by the rewarding method. Alternatively, if the reward is non-monetary, the rewarding module 208 may request one or more external sites or the reward program site 118 to credit a user account with virtual money, reward points, provide a free product or service, and so forth.

The member database 210 may store membership related information, such as user accounts (e.g., names, logins, and passwords) at different social media sites 106. The tracking database 212 may store log files of member activity in the Internet. The relational database 214 may store connection related information associated with members. The reward database 218 may store reward related data, such as rewarding methods, reward amounts associated with members, and so forth.

The users may register and establish personal accounts (profiles) at the reward program site 118 hosted by the web server 202. Personal accounts may include information, such as a name, an address, contact information, earned reward points, and so forth. Companies, which are interested in rewarding customers for sharing their contacts according to various embodiments disclosed herein, may also register with the site 118. Company profiles may comprise company information, such as a name of business, a type of business, an address, contact information, rewarding methods, and the like. The users may access the database 210 via the web server 202 to review, modify or delete information stored therein.

The API 218 may be configured to receive and transmit data between the reward system 104 and any remote device such as the client device 102, the one or more social media site 106, the financial institution server 110, etc. In one example, the API 218 comprises a set of instructions to establish communication between the client device 102 and the reward system 104, or between the social media site 106 and the reward system 104.

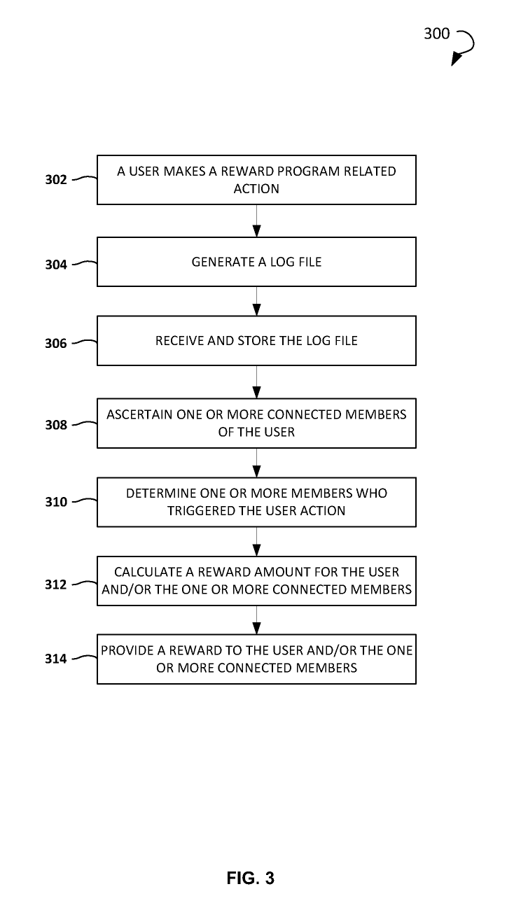

FIG. 3 illustrates a method 300 for operating a reward program according to an example embodiment. The method 300 may commence in operation 302 with the user making a reward program related action.

In one example, the reward program related action may be performed via the reward program site 118, one or more social media sites 106, or any affiliated site that are configured to generate a log file related to such action and deliver the same to the reward system 104. The reward program related action may also be performed offline by making a purchase at a vendor store, for example. When the purchase is processed at the point of sale, the name of the user may be saved for future implementation of the reward program according to various embodiments. Accordingly, in operation 302, a log file associated with the reward program related action is generated and sent to the reward system 104.

In operation 306, the log file may be received by the reward system 104 and is stored in the tracking database 212 in correspondence with the member profile stored in the member database 210. In operation 308, the relational module 206 may query the relational database 214 to retrieve information of user's connected members of reward program site 118 and/or one or more social media sites 106.

In operation 310, the relational module 206 may determine whether any connected members have triggered the user activity. In other words, according to one example embodiment, it may be determined whether there is at least one connected member who previously shared with the user or other connected members a commercial information related to a service or product (as an example) such that the user is then made a purchase decision, i.e. made a reward related action. According to another embodiment, it may be determined whether there is a connected member who previously shared with the user an information related to a survey (as yet another example), and which user is then participated in this survey, i.e. made a reward related action.

In operation 310, it can be determined not only 1^{st} degree of connection relationship, but also 2^{nd} and 3^{rd} degrees. In other words, it may also be determined whether there are at least two connected members, which one of them previously shared commercial information with the other connected member, and whether the latter has further shared this information with the user who finally made a purchase decision. Similarly, the chain of connected members can be determined for any degree of connection relationships.

In operation 312, reward amounts for the user who made the reward related action may be calculated, and also for connected members who were involved in triggering the reward related action (i.e. involved in delivering the information, which caused to make a purchase decision, by the member, in one example). The reward amounts can be calculated and assigned to the members depending on predetermined criteria. In one example, the reward methods may require that only the user who made a reward related action is provided with a reward. In another example, the user who made a reward related action and each member of the 1^{st}, 2^{nd}, and 3^{rd} degree of connection relationship may be provided with corresponding rewards. In yet another example, the rewards may be provided to the user who made a reward related action and to the members of the 1^{st}, 2^{nd}, and 3^{rd} degree of connection relationship whose activities on the Internet are the highest within a certain time period or rank the highest. In addition, different filters can be applied so that a reward can be calculated (and assigned) to the user/members of a specific geographic location, or based on other available demographic information.

In operation 314, the rewarding module 208 may provide a reward to the user or members as defined in the previous operation according to one or more rewarding methods stored in the reward database 216. The rewarding module 208 may provide the reward to the user via one or more destinations. Rewarding methods comprise conditions and requirements to be satisfied so that the user/connected members get rewards. If the reward is monetary, the rewarding module 208 may request one or more financial institution servers 110 to credit corresponding accounts of the user who made the reward related action or connected members. Alternatively, if the reward is non-monetary, the rewarding module 208 may request one or more external sites or the reward program site 118 to credit the user or connected members accounts with virtual money, reward points, provide a free product (including a downloadable product or part of a product), free service, and so forth.

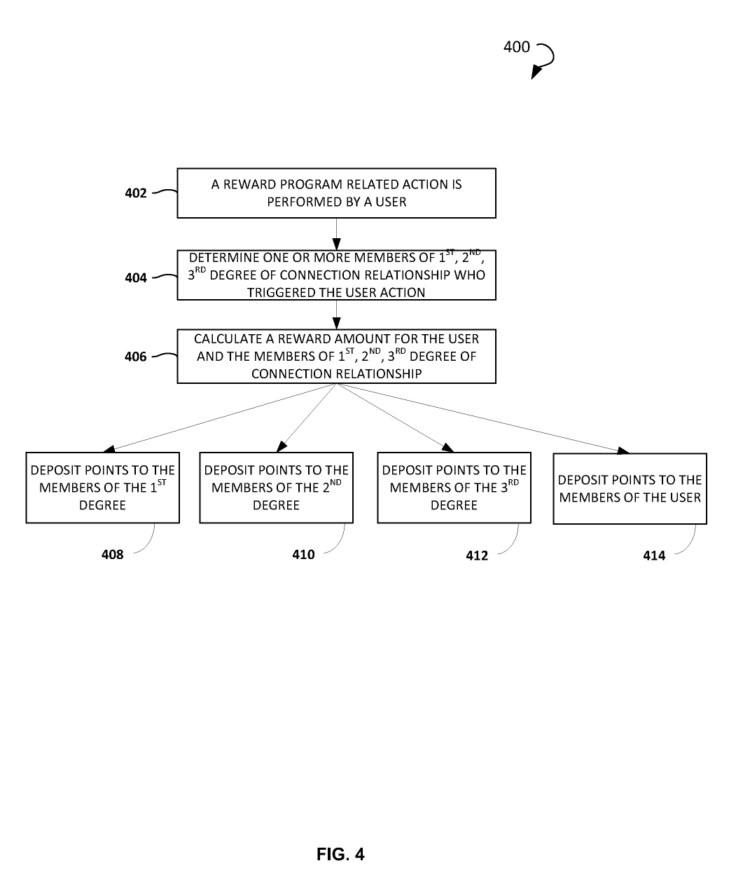

FIG. 4 shows a method 400 for operating a reward program according to an exemplary embodiment. The method 400 may commence in operation 402 with the user making a reward program related action, which may be recorded by the tracking module 204 in the tracking database 212.

In operation 404, the relation module 206 may determine one or more connected members and their degree of connection relationship based on the data stored in the relational database 214 and/or based on the data retrieved from one or more remote social media sites 106. All connected members may be separated by their degree of connection relationship. As mentioned above, 1st degree members relates to members directly connected through a certain social media site 106 (i.e. “friends”). The 2^{nd} degree members designate “friends of friends” or members who have a common connected member. The 3^{rd} degree members designate “friends of friends of friends”, or two or more members who connected to other two connected members, which in turn are directly connected with each other.

In operation 406, rewards for the user and the members of each 1^{st}, 2^{nd}, and, 3^{rd} degree of connection relationship may be calculated. The amount of reward can depend on predetermined criteria. In one example, rewards may be provided to the user who performed a reward related action and to the connected members of the 1^{st}, 2^{nd}, and 3^{rd} degree of connection relationship whose activities on the Internet are the highest within a certain time period or whose rank is the highest, and which members were involved in delivering promotional information to the user who made the purchase. Furthermore, rewards can be calculated for those connected members and/or the user who has profile data within the one or more social media sites 106 satisfying the predetermined criteria. The predetermined criteria may comprise one or more of demographic data, an age, a gender, an occupation, a geographical location of the user or one or more connected members, a purchase amount, amount spent, a number of connected members, and so forth.

In operations 408-414, the reward points may be provided to each connected member of the 1^{st}, 2^{nd}, 3^{rd} degree of connection relationship who triggered the user activity and to the user.

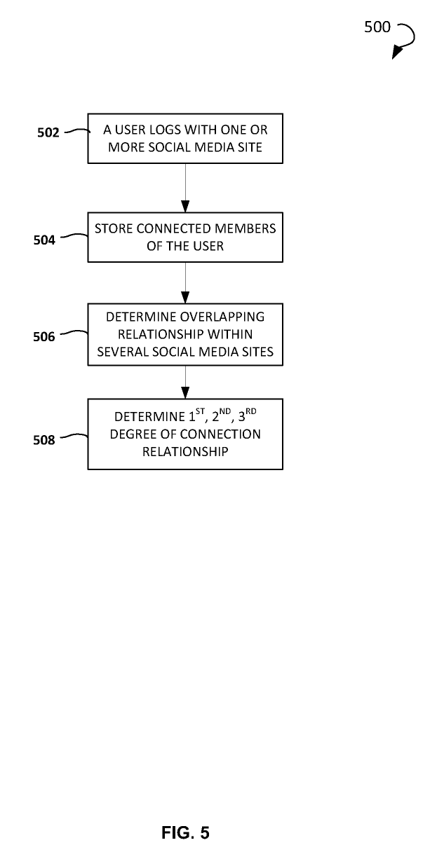

FIG. 5 illustrates a method 500 for determining a 1^{st}, 2^{nd}, 3^{rd} degree of connection relationship according to example embodiment. The method 500 may commence in operation 502 when the user logs into one or more social media sites 106. In the next operation 504, information related to connected members may be transferred to the reward system 104 via a corresponding API of the social media site 106, and then stored in the relational database 214.

In operation 506, the connections of the user within different social media sites 106 may compared to each other to determine whether there are duplicates. If any duplicates are found (i.e. it is found a connected member in at least two different social media sites), such duplicates are eliminated so that the reward is not be granted to the same member twice.

In operation 508, connected members of the connected members determined in operation 504 (i.e. ascertained are “friends of friends”) may be ascertained. In this operation, “friends of friends of friends” may be ascertained, or members of the 2^{nd} degree of relationship. In other words, the method 500 may allow ascertaining members of the 1^{st}, 2^{nd}, 3^{rd} degree of connection relationship to a particular user. This method 5000 can be performed within the data stored in the relational database 214 or the data accessible via one or more social media sites 106, or the reward program site 118.

In some example embodiments, a countdown can be started for a predetermined period of time after a member makes a rewardable purchase at a merchant. Within the predetermined period of time, a predetermined discount can be provided to a certain number of first members connected to the member, provided that the members make a qualified purchase at the same merchant. For example, the member may buy something and reward points. Then a countdown may starts for 48 hours that anyone of the member's social network makes a qualified purchase at that same merchant they receive 50% discount within the time period. Only a certain number of people (e.g., the first 5) may be eligible to get the discount (e.g., 50%). The member may be asked to go to a location of the merchant to find out whether they are first 5 people.

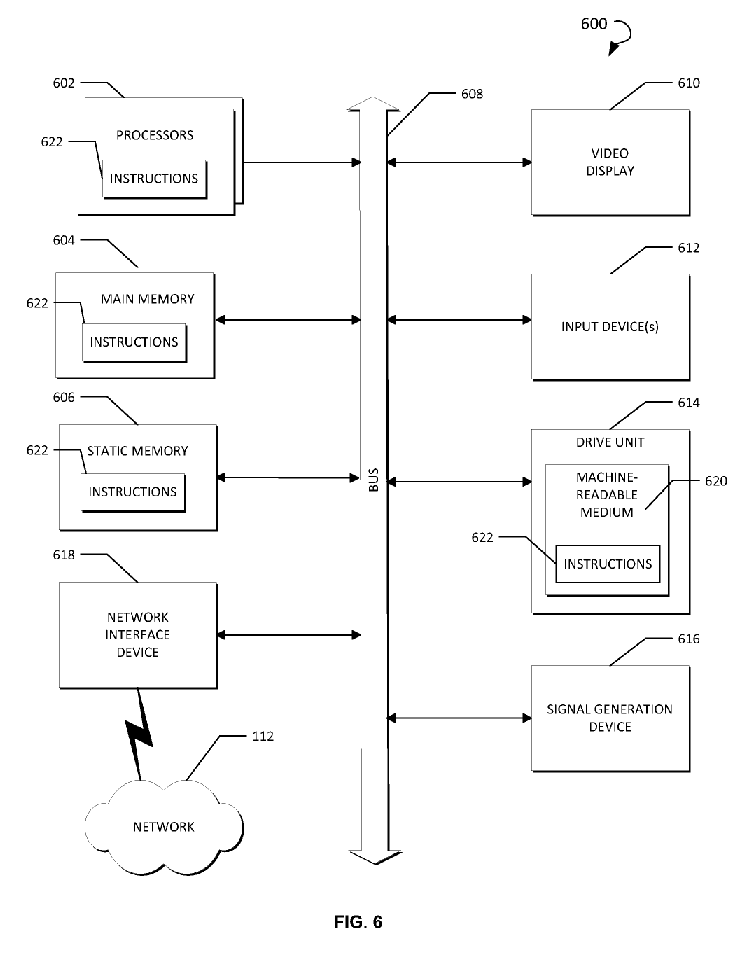

FIG. 6 shows a diagrammatic representation of a computing device for a machine in the example electronic form of a computer system 600, within which a set of instructions for causing the machine to perform any one or more of the methodologies discussed herein can be executed. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a PDA, a cellular telephone, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor or multiple processors 602 (e.g., a central processing unit (CPU), a graphics processing unit (GPU), or both), and a main memory 604 and a static memory 606, which communicate with each other via a bus 608. The computer system 600 can further include a video display unit 610 (e.g., a liquid crystal displays (LCD) or a cathode ray tube (CRT)). The computer system 600 also includes at least one input device 612, such as an alphanumeric input device (e.g., a keyboard), a cursor control device (e.g., a mouse), a microphone, and so forth. The computer system 600 also includes a disk drive unit 614, a signal generation device 616 (e.g., a speaker), and a network interface device 618.

The disk drive unit 414 includes a computer-readable medium 620, which stores one, or more sets of instructions and data structures (e.g., instructions 622) embodying or utilized by any one or more of the methodologies or functions described herein. The instructions 606 and 622 can also reside, completely or at least partially, within the main memory 604 and/or within the engines 602 during execution thereof by the computer system 600. The main memory 604 and the engines 602 also constitute machine-readable media.

The instructions 622 can further be transmitted or received over the network 112 via the network interface device 618 utilizing any one of a number of well-known transfer protocols (e.g., Hyper Text Transfer Protocol (HTTP), CAN, Serial, and Modbus).

While the computer-readable medium 620 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAMs), read only memory (ROMs), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion or other compilers, assemblers, interpreters or other computer languages or platforms.

Thus, the method for operating a reward program has been described. The method allows uniquely rewarding members of social media sites based on their online and offline activity, or based on activity of members connected to them. The disclosed method encourages Internet users to spread commerce-related content via social media sites to connected members for a reward.

Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A computer-implemented method for operating a reward program, the method comprising:
receiving a log file of user activity at a reward program site, the user being a member of one or more social media sites;
ascertaining one or more connected members who are connected to the user within the one or more social media sites;
determining whether the one or more connected members triggered the user activity; and
providing a reward to the one or more connected members who triggered the user activity and/or to the user based on predetermined criteria.

2. The computer-implemented method of claim 1, wherein the user activity comprises one or more of the following: a purchase, a click, a site visit, playing a game, registering with a website, answering a trivia question, signing up for a service or a product, wining a contest, taking a survey, a mobile check in, taking a picture, scanning a code, voting, responding by voice, reading a page, unlocking a badge, uploading a video, taking a quiz, flaging content, RSVPing to an event, writing a review, and posting a comment.

3. The computer-implemented method of claim 1, further comprising receiving user credentials, the user credentials being used for accessing one or more social media sites or the reward program site.

4. The computer-implemented method of claim 1, wherein the determining of one or more connected members includes determining 1^{st}, 2^{nd}, and 3^{rd} degree of connection relationship between the user and connected members, and wherein the 1^{st} degree relates to two or more members that are directly connected in one or more social media sites, the 2^{nd} degree relating to two or more members that are connected to each other via a common member, and the 3^{rd} degree relating to two or more members that are connected to each other via two intermediate members that are in their turn directly connected to each other, and separately connected to the two or more members.

5. The computer-implemented method of claim 4, wherein the providing the reward to the user and/or connected member is based on the degree of connection relationship.

6. The computer-implemented method of claim 1, wherein the reward for a member of 1^{st}, 2^{nd}, or 3^{rd} degree is a percentage of the reward assigned to the user or another member.

7. The computer-implemented method of claim 1, wherein the amount of reward provided to the connected members depends on a number of activities performed within a predetermined time period.

8. The computer-implemented method of claim 1, wherein the user activity is performed at the reward program site, at an affiliated site, a vendor store, or a service provider.

9. The computer-implemented method of claim 1, further comprising determining the relationships among connected members in two or more different social media sites.

10. The computer-implemented method of claim 9, further comprising:
determining the 1^{st}, 2^{nd}, and 3^{rd} degree of connection relationship among connected members in two or more different social media sites; and
determining overlapping relationships between connected members.

11. The computer-implemented method of claim 1, further comprising determining the user activity within a set or variable period of time, wherein the user activity is measured in activity points.

12. The computer-implemented method of claim 11, further comprising assigning a rank to the user or connected members depending on their activity points.

13. The computer-implemented method of claim 11, wherein the providing a reward to the one or more connected members or the user is based on the assigned rank.

14. The computer-implemented method of claim 1, further comprising navigating the user to the reward program site to incorporate the user's person-to-person connections in one or more social media sites.

15. The computer-implemented method of claim 1, further comprising:
generating a log file of the user activity; and
tracking the user activity by processing the log files.

16. The computer-implemented method of claim 1, further comprising:
storing log files in a member database; and
storing rewards amount in a reward database.

17. The computer-implemented method of claim 1, wherein the reward comprises one or more of monetary incentive, non-monetary incentive, virtual money, reward points, bonus points, a financial discount percentage, a rebate amount, a free service, and a free product.

18. The computer-implemented method of claim 1, wherein the one or more social media comprises a social networking site, a blog, a micro-blog, software, a computer game, and a mobile application.

19. The computer-implemented method of claim 1, wherein the predetermined criteria comprises one or more of demographic data, an age, a gender, an occupation, a geographical location of the user of one or more connected members, a purchase amount, an amount spent, an internet activity, and a number of connected members.

20. The computer-implemented method of claim 19, wherein the reward is provided to those connected members and/or to the user who have profile data within the one or more social media sites satisfying the predetermined criteria.

21. The computer-implemented method of claim 19, wherein the amount of reward is calculated based on the predetermined criteria.

22. The computer-implemented method of claim 1, further comprising:
starting a countdown for a predetermined period of time after a member makes a rewardable purchase at a merchant; and
within the predetermined period of time, providing a predetermined discount to a certain number of first one or more members connected to the member within a social network, provided that the one or more members make a qualified purchase at the same merchant.

23. An apparatus for operating a reward program, comprising:
at least one processor configured to:
receive a log file of user activity at a reward program site, the user being a member of one or more social media sites;
ascertain one or more connected members who are connected to the user within the one or more social media sites;
determine whether the one or more connected members triggered the user activity; and
provide a reward to the one or more connected members who triggered the user activity and/or the user based on predetermined criteria; and
a memory coupled to the at least one processor, the memory comprising codes for the at least one processor.

24. A computer-readable medium having instructions stored thereon, which when executed by one or more computers, cause the one or more computers to:
receive a log file of user activity at a reward program site, the user being a member of one or more social media sites;
ascertain one or more connected members who are connected to the user within the one or more social media sites;
determine whether the one or more connected members triggered the user activity; and
provide a reward to the one or more connected members who triggered the user activity and/or the user based on predetermined criteria.
